(19) United States
(12) Patent Application Publication
(10) Pub. No.: US 2004/0053136 A1
(43) Pub. Date: Mar. 18, 2004

(54) Lithium carbide composition, cathode, battery and process

(76) Inventor: William C. Bauman, Midland, MI (US)

Correspondence Address: TIMOTHY S. STEVENS, 5108 FOXPOINT, MIDLAND, MI, 48642, US

(21) Appl. No.: 10/243,532

(22) Filed: Sep. 13, 2002

(51) Int. Cl. H01M 4/58; H01B 1/04; H01M 4/62

(52) U.S. Cl. 429/231.4; 429/231.8; 252/182.1; 429/232; 252/504

(57) ABSTRACT

The gist of the instant invention is the use of lithium carbide in the cathode of a rechargeable lithium ion battery. Lithium carbide is used to electrochemically release electrons and lithium ions from the cathode. A preferred cathode of the instant invention is graphite intercalated with a mixture of lithium carbide and a lithium salt such as lithium tetrafluoroborate.

### BACKGROUND

Lithium ion rechargeable batteries (for example, the battery disclosed in U.S. Pat. No. 5,989,744) are a commercially successful source of portable electric power for cell phones and other electronic devices. The anode of a fully charged lithium ion rechargeable battery is usually graphite intercalated with metallic lithium. The cathode of such a battery is usually a mixture of graphite (or other electrically conductive carbonaceous material) and, for example, a cobalt oxide compound. The anode and cathode are usually immersed in a non-aqueous solution of lithium salt and separated by a porous polymer separator. During the discharge of such a battery, the metallic lithium of the anode gives up electrons to produce lithium ions that diffuse toward the cathode where lithium ions react with the cobalt oxide compound and the electrons to form a lithium cobalt oxide compound. During the recharging of such a battery, the lithium cobalt oxide compound gives up electrons to produce lithium ions that diffuse toward the anode where the lithium ions react with the electrons to produce metallic lithium.

Many improvements have been made to lithium ion batteries. Currently available lithium ion batteries using cobalt oxide material in the cathode provide excellent power to weight, cell voltage and cycle life characteristics. However, the cobalt oxide materials used in the cathode are relatively expensive, toxic and flammable. It would be an advance in the lithium ion battery art if a material were discovered to replace the cobalt oxide material that was less expensive, less toxic and non-flammable.

### SUMMARY OF THE INVENTION

The central theme of the instant invention is the use of lithium carbide in the cathode of a lithium ion battery. It has been discovered that lithium carbide can be used to replace the prior art materials (such as a lithium cobalt oxide material) used in the cathode of a lithium ion battery to electrochemically release electrons and lithium ions. Lithium carbide is relatively inexpensive, non-toxic and non-flammable. A preferred cathode of the instant invention for use in a lithium ion rechargeable battery comprises graphite intercalated with a mixture of lithium carbide and a lithium salt such as lithium tetrafluoroborate.

In one embodiment, the instant invention is a composition of matter, comprising: graphite, the layers of covalently bonded carbon atoms of the graphite being intercalated with lithium carbide, the mole ratio of carbon of the graphite to the carbon of the lithium carbide being less than one hundred.

In another embodiment, the instant invention is a process for making a composition of matter comprising graphite, the layers of covalently bonded carbon atoms of the graphite being intercalated with lithium carbide, the mole ratio of carbon of the graphite to the carbon of the lithium carbide being less than one hundred, the process comprising the step of: contacting graphite with molten lithium carbide, the mole ratio of carbon of the graphite to the carbon of the lithium carbide being less than one hundred.

In yet another embodiment, the instant invention is a process for making a composition of matter comprising graphite, the layers of covalently bonded carbon atoms of the graphite being intercalated with lithium carbide and a lithium salt, the mole ratio of carbon of the graphite to the carbon of the lithium carbide being less than one hundred, the mole ratio of carbon of the graphite to the lithium of the lithium salt being less than one hundred, the process comprising the step of: contacting graphite with a molten mixture of lithium carbide and lithium salt, the mole ratio of carbon of the graphite to the carbon of the lithium carbide being less than one hundred, the mole ratio of carbon of the graphite to the lithium of the lithium salt being less than one hundred.

In another embodiment, the instant invention is an improved lithium ion secondary battery of the type comprising an anode, a graphite cathode, a porous separator between the anode and the cathode and an electrolyte in ion conducting contact with the anode, the cathode and the porous separator, wherein the improvement comprises: the layers of covalently bonded carbon atoms of the graphite of the cathode being intercalated with lithium carbide when the improved battery is in the discharged state, the mole ratio of carbon of the graphite to the carbon of the lithium carbide being less than one hundred.

In another embodiment, the instant invention is an improved cathode for a lithium ion secondary battery, the cathode comprising an electrically conductive carbonaceous material and a precursor dispersed in the electrically conductive carbonaceous material, which precursor reacts with lithium ion to produce a lithium compound when the lithium ion secondary battery is being discharged, wherein the improvement comprises: that the lithium compound is lithium carbide, the mole ratio of carbon of the electrically conductive carbonaceous material to the carbon of the lithium carbide being less than one hundred.

In another embodiment, the instant invention is a process for producing electricity, comprising the steps of: (a) conducting electrons from metallic lithium to produce lithium ions; and (b) reacting lithium ions with lithium depleted lithium carbide and the electrons to form lithium carbide.

In another embodiment, the instant invention is a process for storing electricity, comprising the steps of: (a) conducting electrons from lithium carbide to produce lithium ions; and (b) reacting lithium ions with the electrons to form metallic lithium.

### BRIEF DESCRIPTION OF THE DRAWINGS

FIG. 1 is a cross-sectional schematic side view of a prior art lithium ion rechargeable battery in its recharge mode;

FIG. 2 is a cross-sectional schematic side view of a prior art lithium ion rechargeable battery in its discharge mode;

FIG. 3 is a cross-sectional schematic side view of a lithium ion rechargeable battery of the instant invention in its recharge mode; and

FIG. 4 is a cross-sectional schematic side view of a lithium ion rechargeable battery of the instant invention in its discharge mode.

### DETAILED DESCRIPTION OF THE INVENTION

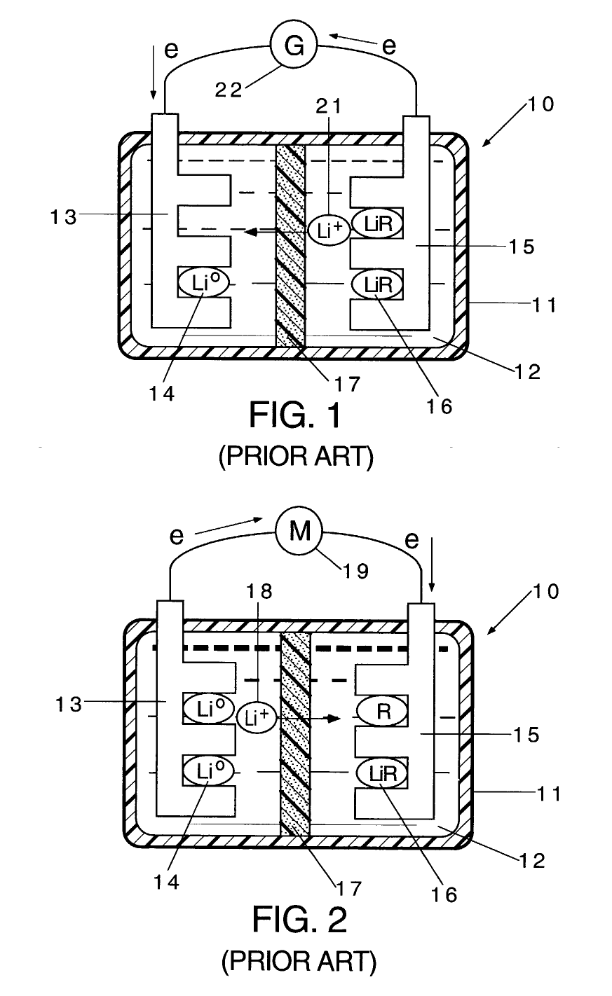

Referring now to FIGS. 1 and 2, therein is shown a cross-sectional schematic side view of a prior art lithium ion rechargeable battery 10 having a case 11 containing a non-aqueous solution or gel 12 of lithium salt (such as LiPF₆ or LiBF₄ dissolved in ethylene or propylene carbonate). The anode 13 of a recharged battery 10 is typically graphite intercalated with metallic lithium (but the anode can simply be an electrode made of lithium metal). The anode 13 is shown in schematic form with the crystalline layers of the graphite depicted as being connected at one edge thereof. The cathode 15 is typically an electrically conductive carbonaceous material such as graphite having a lithium compound 16 dispersed therewith. The cathode 15 is also shown in schematic form as graphite with the crystalline layers of the graphite depicted as being connected at one edge thereof. The lithium compound 16 is typically a lithium cobalt oxide material. An optional porous separator 17 is used to prevent contact between the anode 13 and the cathode 15. The separator 17 is typically a porous polymer such as porous polyethylene or porous polypropylene.

Referring now to FIG. 1, when the battery 10 is recharged, electrons are conducted from the lithium compound 16 by the cathode 15 to produce lithium ions 21. The electrons flow through the generator 22 (or other such source of electricity) to the anode 13. Lithium ions diffuse through the separator 17 to the anode 13. The lithium ions react with the electrons in the anode 13 to form metallic lithium 14 intercalated in the graphite anode 13.

Referring now to FIG. 2, when the battery 10 is discharged, electrons are conducted from the metallic lithium 14 by the anode 13 to produce lithium ions 18. The electrons flow through the motor 19 (or other load) to the cathode 15. Lithium ions diffuse through the separator 17 to the cathode 15. Lithium ions react with a precursor material (such as a cobalt oxide) and the electrons to form the lithium compound 16. The relative voltage difference between the anode 13 and the cathode 15 is typically about 3.6 volts.

The following United States Patents (herein fully incorporated by reference) will provide a person skilled in the art with a review of the lithium ion rechargeable battery art: U.S. Pat. Nos. 4,687,716; 4,828,834; 5,053,297; 5,168,019; 5,273,842; 5,292,601; 5,370,710; 5,427,874; 5,427,875; 5,437,945; 5,451,477; 5,474,752; 5,561,005; 5,580,684; 5,629,107; 5,639,575; 5,683,672; 5,691,620; 5,705,292; 5,709,969; 5,714,281; 5,763,119; 5,773,165; 5,804,333; 5,834,138; 5,972,536; 5,989,744; 6,022,641; 6,064,182; 6,066,414; 6,083,646; 6,093,505; 6,120,938; 6,124,700; 6,127,065; 6,146,790; 6,277,516; 6,300,013; 6,335,122; 6,395,428; and 6,440,609.

In one embodiment the instant invention is a composition of matter comprising graphite wherein the layers of covalently bonded carbon atoms of the graphite are intercalated with lithium carbide and wherein the mole ratio of carbon of the graphite to the carbon of the lithium carbide is less than one hundred. Preferably, the mole ratio of carbon of the graphite to the carbon of the lithium carbide is less than thirty. More preferably, the mole ratio of carbon of the graphite to the carbon of the lithium carbide is less than ten. Even more preferably, the mole ratio of carbon of the graphite to the carbon of the lithium carbide is less than three. The maximum amount of lithium carbide that can be intercalated in graphite is probably a mole ratio of carbon of the graphite to the carbon of the lithium carbide of about one half. Lower mole ratios of the carbon of the graphite to the carbon of the lithium carbide result in a higher capacity for a given volume or weight of cathode but compositions having the maximum amount of lithium carbide intercalated in the graphite are not preferred because it is believed that such compositions will probably show relatively slower lithium ion conductivity.

It is also preferable that a lithium salt or mixture of lithium salts also be intercalated into the graphite, the mole ratio of carbon of the graphite to the lithium of the lithium salt(s) being less than one hundred. The presence of the lithium salt(s) reduces the maximum amount of lithium carbide that can be used but increases the lithium ion conductivity of the composition. Preferably, the mole ratio of carbon of the graphite to the lithium of the lithium salt(s) is less than thirty. More preferably, the mole ratio of carbon of the graphite to the lithium of the lithium salt(s) is less than ten. Most preferably, the mole ratio of carbon of the graphite to the carbon of the lithium carbide is less than three and the mole ratio of lithium salt(s) to lithium carbide is about one to three. Lithium salts that can be used for this purpose include LiClO₄, LiPF₆, LiAsF₆, LiBF₄, LiCF₃SO₃, and LiN(CF₃SO₂)₂ and probably even LiCl and LiF. Most preferably, the lithium salt used consists essentially of lithium tetrafluoroborate (LiBF₄). The term “consists essentially of lithium tetrafluoroborate” means the commercial grade of lithium tetrafluoroborate.

Graphite is the preferred matrix material for the improved cathode of the instant invention. However, it is believed that in the full scope of the instant invention it is possible to disperse the lithium carbide in any electrically conductive carbonaceous material such as the prior art electrically conductive carbonaceous materials for the cathode of a lithium ion rechargeable battery disclosed in the patent references above.

Crystalline Lithium carbide can be made by reacting lithium metal with carbon at 800-900 degrees Celsius (Juza, et al., Zeitschrift fur Anorganische und Allgemeine Chemie, 352, pp252-257, (1967)) or by reacting lithium carbonate with carbon at 800-950 degrees Celsius (Kroger, et al., Zeitschrift fur Anorganische und Allgemeine Chemie, 212, pp 269-283 (1933)). Crystalline lithium carbide is reported to melt at about 450 degrees Celsius (Inorg. Mater. (Transl. Of Neorg. Mater.) (1997), 33,(11), 1103-1105. Lithium carbide intercalates into graphite when molten lithium carbide is exposed to graphite. A mixture of lithium carbide and lithium salt(s) intercalates into graphite when a molten mixture of lithium carbide and the salt(s) is exposed to graphite. For example, lithium carbide and lithium tetrafluoroborate intercalates into graphite when a molten mixture of lithium carbide and lithium tetrafluoroborate is exposed to graphite. Prior to such exposure, the graphite is preferably heated to four hundred degrees Celsius under vacuum for one hour to remove adsorbed gasses and other adsorbed impurities.

In another embodiment, the instant invention is an improved lithium ion rechargeable battery, i.e., a “secondary battery”, of the type comprising an anode, a graphite cathode, a porous separator between the anode and the cathode and an electrolyte in ion conducting contact with the anode, the cathode and the porous separator. The constitution of the conventional components of the battery of the instant invention such as the anode, the separator, the electrolyte solvent, the battery case and shape is not limited to a particular type. The improvement of the instant invention is to use the above-described composition of matter as the cathode.

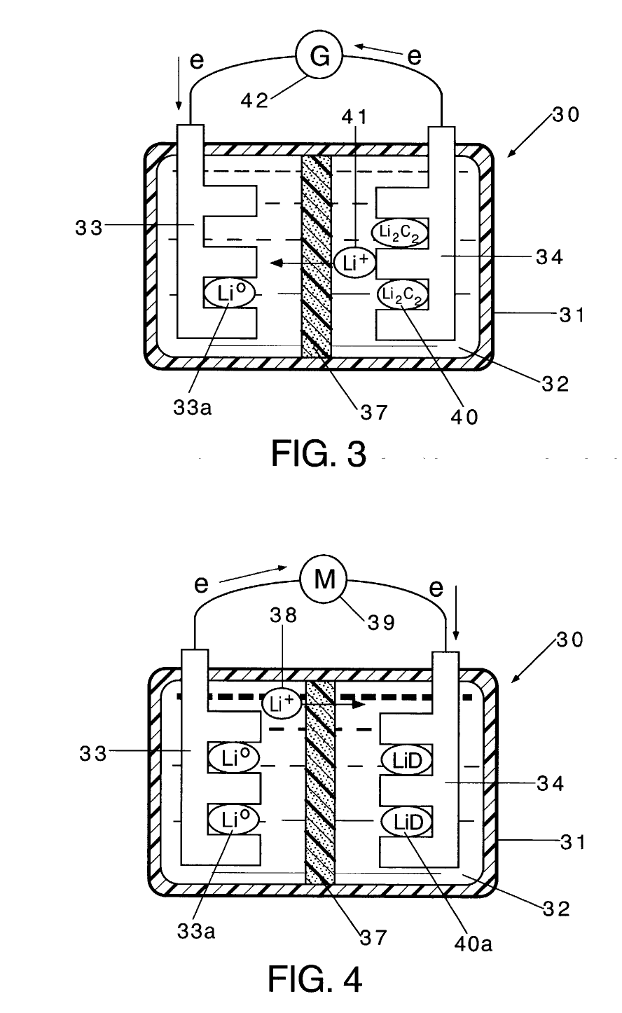

Referring now to FIGS. 3 and 4, therein is shown a cross-sectional schematic side view of a lithium ion rechargeable battery 30 according to the instant invention having a case 31 containing a non-aqueous solution 32 of lithium salt(s) (such as LiBF₄ dissolved in ethylene or propylene carbonate). The anode 33 is typically graphite to be intercalated with metallic lithium 33a. The cathode 34 is graphite intercalated with lithium carbide 40 (or lithium carbide dispersed in another electrically conductive carbonaceous material). An optional porous separator 37 is used to prevent inadvertent contact between the anode 33 and the cathode 34.

The term “intercalated” used herein with regard to graphite means that a material has entered between the crystal lattice planes of the graphite. For example, it is well known in the lithium ion rechargeable battery art that lithium ions can diffuse between the crystal lattice planes of graphite and react with electrons to produce a metallic form of lithium, i.e., lithium in the neutral charge state, with a maximum metallic lithium loading of about one lithium per six carbons of the graphite. Lithium carbide can also enter between the crystal lattice planes of graphite to produce graphite intercalated with lithium carbide.

Referring now to FIG. 3, when the battery 30 is recharged, electrons are conducted from the lithium carbide 40 by the cathode 34 to produce lithium ions 41. The electrons flow through the generator 42 (or other such source of electricity) to the anode 33. Lithium ions diffuse through the separator 37 to the anode 33. The lithium ions react with the electrons in the anode 33 to form metallic lithium 33a intercalated in the graphite anode 33.

Referring now to FIG. 4, when the battery 30 is discharged, electrons are conducted from the metallic lithium 33a by the anode 33 to produce lithium ions 38. The electrons flow through the motor 39 (or other load) to the cathode 34. Lithium ions diffuse through the separator 37 to the cathode 34. Lithium ions react with lithium depleted lithium carbide 40a and the electrons to form lithium carbide. The voltage difference between the anode 33 and the cathode 34 provides the electrical driving force for powering the motor 39 or other electrical load.

In the above discussion the term “lithium depleted lithium carbide” is used to describe the material that is left behind when lithium ions and electrons are removed from the lithium carbide 40. The exact nature of lithium depleted lithium carbide is not known and does not need to be known to make and use the instant invention. However, lithium depleted lithium carbide is probably a mixture of Li₂C₂, LiC₂ and perhaps C₂ (plus the lithium salt, if used) in various ratios depending on the state of charge of the cathode. Or, perhaps lithium depleted lithium carbide is a hybrid solid-state glassy material of formula LiₓC₂ (plus the lithium salt, if used) where the value of x varies (perhaps from zero to two) depending on the state of charge of the cathode. Preferably, the amount of lithium depleted from the lithium carbide of a fully recharged cathode of the instant invention is less than one half of the theoretical maximum amount that is available.

### EXAMPLE 1

Crystalline lithium carbide is synthesized and purified as described by Juza, et al., Zeitschrift fur Anorganische und Allgemeine Chemie, 352, pp252-257, (1967). Twelve grams of 200-400 mesh sized graphite is heated to four hundred degrees Celsius in a vacuum for one hour. 11.72 grams of lithium tetrafluoroborate and 14.22 grams of crystalline lithium carbide are mixed, melted and added to the graphite. After the graphite absorbs the molten mixture of lithium tetrafluoroborate and lithium carbide the resulting product is cooled to room temperature and wetted with a saturated solution of lithium tetrafluoroborate in propylene carbonate in a dry box.

A discharged prior art lithium ion rechargeable battery having an electrolyte of lithium tetrafluoroborate in propylene carbonate is disassembled in the dry box. The wetted graphite/lithium carbide/lithium tetrafluoroborate composition is pressed into the same shape as the cathode removed from the prior art lithium ion rechargeable battery. The prior art lithium ion rechargeable battery is reassembled using all of its original components but replacing its original cathode with the cathode pressed from the graphite/lithium carbide/lithium tetrafluoroborate composition to produce a lithium ion rechargeable battery according to the instant invention.

### EXAMPLE 2

Crystalline lithium carbide is synthesized and purified as described by Kroger, et al., Zeitschrift fur Anorganische und Allgemeine Chemie, 212, pp 269-283 (1933). Twelve grams of 200-400 mesh sized graphite is heated to four hundred degrees Celsius in a vacuum for one hour. Four grams of lithium tetrafluoroborate and five grams of crystalline lithium carbide are mixed, melted and added to the graphite. After the graphite absorbs the molten mixture of lithium tetrafluoroborate and lithium carbide the resulting product is cooled to room temperature and wetted with a saturated solution of lithium tetrafluoroborate in propylene carbonate in a dry box.

A discharged prior art lithium ion rechargeable battery having an electrolyte of lithium tetrafluoroborate in propylene carbonate is disassembled in the dry box. The wetted graphite/lithium carbide/lithium tetrafluoroborate composition is pressed into the same shape as the cathode removed from the prior art lithium ion rechargeable battery. The prior art lithium ion rechargeable battery is reassembled using all of its original components but replacing its original cathode with the cathode pressed from the graphite/lithium carbide/lithium tetrafluoroborate composition to produce a lithium ion rechargeable battery according to the instant invention.

### EXAMPLE 3

The example of Example 1 is repeated except that no lithium tetrafluoroborate is used and two grams of crystalline lithium carbide is used.

### EXAMPLE 4

The example of Example 1 is repeated except that 4.7 grams of crystalline lithium carbide is used.

### EXAMPLE 5

The example of Example 1 is repeated except that 2.4 grams of crystalline lithium carbide is used.

### EXAMPLE 6

This example is of an improved lithium ion rechargeable battery of the instant invention in the shape of a coin. Crystalline lithium carbide is prepared and purified as described by Kroger, et al., Zeitschrift fur Anorganische und Allgemeine Chemie, 212, pp 269-283 (1933). Twelve grams of 200-400 mesh sized graphite is heated to four hundred degrees Celsius in a vacuum for one hour. 11.72 grams of lithium tetrafluoroborate and 14.22 grams of crystalline lithium carbide are mixed, melted and added to the graphite. After the graphite absorbs the molten mixture of lithium tetrafluoroborate and lithium carbide the resulting product is cooled to room temperature and wetted with a saturated solution of lithium tetrafluoroborate in propylene carbonate in a dry box. A portion of the wetted graphite/lithium carbide/lithium tetrafluoroborate composition is pressed in the dry box into a disk shaped cathode one millimeter thick and ten millimeters in diameter.

Twelve grams of 200-400 mesh sized graphite is heated to four hundred degrees Celsius in a vacuum for one hour, cooled to room temperature and then wetted with a saturated solution of lithium tetrafluoroborate in propylene carbonate in the dry box. A portion of the wetted graphite is pressed in the dry box into a disk shaped anode two millimeters thick and ten millimeters in diameter.

A one half millimeter thick and ten millimeter diameter porous polypropylene disk shaped separator is wetted with a saturated solution of lithium tetrafluoroborate in propylene carbonate in the dry box. The cathode, separator and anode are stacked together and sealed in a close fitting polypropylene case having sealed in electrical leads to the anode and to the cathode.

What is claimed is:

1. A composition of matter, comprising: graphite, the layers of covalently bonded carbon atoms of the graphite being intercalated with lithium carbide, the mole ratio of carbon of the graphite to the carbon of the lithium carbide being less than one hundred.

2. The composition of matter of claim 1, wherein the mole ratio of carbon of the graphite to the carbon of the lithium carbide is less than thirty.

3. The composition of matter of claim 1, wherein the mole ratio of carbon of the graphite to the carbon of the lithium carbide is less than ten.

4. The composition of matter of claim 1, wherein the mole ratio of carbon of the graphite to the carbon of the lithium carbide is less than three.

5. The composition of matter of claim 1, wherein the layers of covalently bonded carbon atoms of the graphite are also intercalated with a lithium salt, the mole ratio of carbon of the graphite to the lithium of the lithium salt being less than one hundred.

6. The composition of matter of claim 2, wherein the layers of covalently bonded carbon atoms of the graphite are also intercalated with a lithium salt, the mole ratio of carbon of the graphite to the lithium of the lithium salt being less than thirty.

7. The composition of matter of claim 3, wherein the layers of covalently bonded carbon atoms of the graphite are also intercalated with a lithium salt, the mole ratio of carbon of the graphite to the lithium of the lithium salt being less than thirty.

8. The composition of matter of claim 4, wherein the layers of covalently bonded carbon atoms of the graphite are also intercalated with a lithium salt, the mole ratio of carbon of the graphite to the lithium of the lithium salt being less than ten.

9. The composition of matter of claim 5, wherein the lithium salt comprises lithium tetrafluoroborate.

10. The composition of matter of claim 6, wherein the lithium salt comprises lithium tetrafluoroborate.

11. The composition of matter of claim 7, wherein the lithium salt comprises lithium tetrafluoroborate.

12. The composition of matter of claim 8, wherein the lithium salt comprises lithium tetrafluoroborate.

13. The composition of matter of claim 5, wherein the lithium salt consists essentially of lithium tetrafluoroborate.

14. The composition of matter of claim 6, wherein the lithium salt consists essentially of lithium tetrafluoroborate.

15. The composition of matter of claim 7, wherein the lithium salt consists essentially of lithium tetrafluoroborate.

16. The composition of matter of claim 8, wherein the lithium salt consists essentially of lithium tetrafluoroborate.

17. A process for making a composition of matter comprising graphite, the layers of covalently bonded carbon atoms of the graphite being intercalated with lithium carbide, the mole ratio of carbon of the graphite to the carbon of the lithium carbide being less than one hundred, the process comprising the step of: contacting graphite with molten lithium carbide, the mole ratio of carbon of the graphite to the carbon of the lithium carbide being less than one hundred.

18. The process of claim 17, wherein the mole ratio of carbon of the graphite to the carbon of the lithium carbide is less than thirty.

19. The process of claim 17, wherein the mole ratio of carbon of the graphite to the carbon of the lithium carbide is less than ten.

20. The process of claim 17, wherein the mole ratio of carbon of the graphite to the carbon of the lithium carbide is less than three.

21. A process for making a composition of matter comprising graphite, the layers of covalently bonded carbon atoms of the graphite being intercalated with lithium carbide and a lithium salt, the mole ratio of carbon of the graphite to the carbon of the lithium carbide being less than one hundred, the mole ratio of carbon of the graphite to the lithium of the lithium salt being less than one hundred, the process comprising the step of: contacting graphite with a molten mixture of lithium carbide and lithium salt, the mole ratio of carbon of the graphite to the carbon of the lithium carbide being less than one hundred, the mole ratio of carbon of the graphite to the lithium of the lithium salt being less than one hundred.

22. The process of claim 21, wherein the mole ratio of carbon of the graphite to the carbon of the lithium carbide is less than thirty, the mole ratio of carbon of the graphite to the lithium of the lithium salt is less than thirty and wherein the process comprises the step of: contacting graphite with a molten mixture of lithium carbide and lithium salt, the mole ratio of carbon of the graphite to the carbon of the lithium carbide being less than thirty, the mole ratio of carbon of the graphite to the lithium of the lithium salt being less than thirty.

23. The process of claim 21, wherein the mole ratio of carbon of the graphite to the carbon of the lithium carbide is less than ten, the mole ratio of carbon of the graphite to the lithium of the lithium salt is less than thirty and wherein the process comprises the step of: contacting graphite with a molten mixture of lithium carbide and lithium salt, the mole ratio of carbon of the graphite to the carbon of the lithium carbide being less than ten, the mole ratio of carbon of the graphite to the lithium of the lithium salt being less than thirty.

24. The process of claim 21, wherein the mole ratio of carbon of the graphite to the carbon of the lithium carbide is less than three, the mole ratio of carbon of the graphite to the lithium of the lithium salt is less than ten and wherein the process comprises the step of: contacting graphite with a molten mixture of lithium carbide and lithium salt, the mole ratio of carbon of the graphite to the carbon of the lithium carbide being less than three, the mole ratio of carbon of the graphite to the lithium of the lithium salt being less than ten.

25. The process of claim 21, wherein the lithium salt comprises lithium tetrafluoroborate.

26. The process of claim 22, wherein the lithium salt comprises lithium tetrafluoroborate.

27. The process of claim 23, wherein the lithium salt comprises lithium tetrafluoroborate.

28. The process of claim 24, wherein the lithium salt comprises lithium tetrafluoroborate.

29. The process of claim 21, wherein the lithium salt consists essentially of lithium tetrafluoroborate.

30. The process of claim 22, wherein the lithium salt consists essentially of lithium tetrafluoroborate.

31. The process of claim 23, wherein the lithium salt consists essentially of lithium tetrafluoroborate.

32. The process of claim 24, wherein the lithium salt consists essentially of lithium tetrafluoroborate.

33. An improved lithium ion secondary battery of the type comprising an anode, a graphite cathode, a porous separator between the anode and the cathode and an electrolyte in ion conducting contact with the anode, the cathode and the porous separator, wherein the improvement comprises: the layers of covalently bonded carbon atoms of the graphite of the cathode being intercalated with lithium carbide when the improved battery is in the discharged state, the mole ratio of carbon of the graphite to the carbon of the lithium carbide being less than one hundred.

34. The improved battery of claim 33, wherein the mole ratio of carbon of the graphite to the carbon of the lithium carbide is less than thirty.

35. The improved battery of claim 33, wherein the mole ratio of carbon of the graphite to the carbon of the lithium carbide is less than ten.

36. The improved battery of claim 33, wherein the mole ratio of carbon of the graphite to the carbon of the lithium carbide is less than three.

37. The improved battery of claim 33, wherein the layers of covalently bonded carbon atoms are also intercalated with a lithium salt, the mole ratio of carbon of the graphite to the lithium of the lithium salt being less than one hundred.

38. The improved battery of claim 34, wherein the layers of covalently bonded carbon atoms are also intercalated with a lithium salt, the mole ratio of carbon of the graphite to the lithium of the lithium salt being less than thirty.

39. The improved battery of claim 35, wherein the layers of covalently bonded carbon atoms are also intercalated with a lithium salt, the mole ratio of carbon of the graphite to the lithium of the lithium salt being less than thirty.

40. The improved battery of claim 36, wherein the layers of covalently bonded carbon atoms are also intercalated with a lithium salt, the mole ratio of carbon of the graphite to the lithium of the lithium salt being less than ten.

41. The improved battery of claim 37, wherein the lithium salt comprises lithium tetrafluoroborate.

42. The improved battery of claim 38, wherein the lithium salt comprises lithium tetrafluoroborate.

43. The improved battery of claim 39, wherein the lithium salt comprises lithium tetrafluoroborate.

44. The improved battery of claim 40, wherein the lithium salt comprises lithium tetrafluoroborate.

45. The improved battery of claim 37, wherein the lithium salt consists essentially of lithium tetrafluoroborate.

46. The improved battery of claim 38, wherein the lithium salt consists essentially of lithium tetrafluoroborate.

47. The improved battery of claim 39, wherein the lithium salt consists essentially of lithium tetrafluoroborate.

48. The improved battery of claim 40, wherein the lithium salt consists essentially of lithium tetrafluoroborate.

49. An improved cathode for a lithium ion secondary battery, the cathode comprising an electrically conductive carbonaceous material and a precursor dispersed in the electrically conductive carbonaceous material, which precursor reacts with lithium ion to produce a lithium compound when the lithium ion secondary battery is being discharged, wherein the improvement comprises: that the lithium compound is lithium carbide, the mole ratio of carbon of the electrically conductive carbonaceous material to the carbon of the lithium carbide being less than one hundred.

50. The improved cathode of claim 49, wherein the mole ratio of carbon of the electrically conductive carbonaceous material to the carbon of the lithium carbide is less than thirty.

51. The improved cathode of claim 49, wherein the mole ratio of carbon of the electrically conductive carbonaceous material to the carbon of the lithium carbide is less than ten.

52. The improved cathode of claim 49, wherein the mole ratio of carbon of the electrically conductive carbonaceous material to the carbon of the lithium carbide is less than three.

53. The improved cathode of claim 49, wherein a lithium salt is also dispersed in the electrically conductive carbonaceous material, the mole ratio of carbon of the electrically conductive carbonaceous material to the lithium of the lithium salt being less than one hundred.

54. The improved cathode of claim 50, wherein a lithium salt is also dispersed in the electrically conductive carbonaceous material, the mole ratio of carbon of the electrically conductive carbonaceous material to the lithium of the lithium salt being less than thirty.

55. The improved cathode of claim 51, wherein a lithium salt is also dispersed in the electrically conductive carbonaceous material, the mole ratio of carbon of the electrically conductive carbonaceous material to the lithium of the lithium salt being less than thirty.

56. The improved cathode of claim 52, wherein a lithium salt is also dispersed in the electrically conductive carbonaceous material, the mole ratio of carbon of the electrically conductive carbonaceous material to the lithium of the lithium salt being less than ten.

57. The improved cathode of claim 53, wherein the lithium salt comprises lithium tetrafluoroborate and wherein the electrically conductive carbonaceous material comprises graphite.

58. The improved cathode of claim 54, wherein the lithium salt comprises lithium tetrafluoroborate and wherein the electrically conductive carbonaceous material comprises graphite.

59. The improved cathode of claim 55, wherein the lithium salt comprises lithium tetrafluoroborate and wherein the electrically conductive carbonaceous material comprises graphite.

60. The improved cathode of claim 56, wherein the lithium salt comprises lithium tetrafluoroborate and wherein the electrically conductive carbonaceous material comprises graphite.

61. The improved cathode of claim 53, wherein the lithium salt consists essentially of lithium tetrafluoroborate and wherein the electrically conductive carbonaceous material consists essentially of graphite.

62. The improved cathode of claim 54, wherein the lithium salt consists essentially of lithium tetrafluoroborate and wherein the electrically conductive carbonaceous material consists essentially of graphite.

63. The improved cathode of claim 55, wherein the lithium salt consists essentially of lithium tetrafluoroborate and wherein the electrically conductive carbonaceous material consists essentially of graphite.

64. The improved cathode of claim 56, wherein the lithium salt consists essentially of lithium tetrafluoroborate and wherein the electrically conductive carbonaceous material consists essentially of graphite.

65. A process for producing electricity, comprising the steps of: (a) conducting electrons from metallic lithium to produce lithium ions; and (b) reacting lithium ions with lithium depleted lithium carbide and the electrons to form lithium carbide.

66. A process for storing electricity, comprising the steps of: (a) conducting electrons from lithium carbide to produce lithium ions; and (b) reacting lithium ions with the electrons to form metallic lithium.
